(19) United States
(12) Patent Application Publication
(10) Pub. No.: US 2021/0255720 A1
(43) Pub. Date: Aug. 19, 2021

(54) TOUCH DEVICE, TOUCH PANEL, AND MANUFACTURING METHOD FOR SENSING CHANNELS OF TOUCH PANEL

(71) Applicant: SHENZHEN ROYOLE TECHNOLOGIES CO., LTD., Shenzhen, Guangdong (CN)

(72) Inventor: Xianhong PAN, Shenzhen, Guangdong (CN)

(21) Appl. No.: 17/056,289

(22) PCT Filed: May 18, 2018
(86) PCT No.: PCT/CN2018/087545

§ 371 Date: Nov. 17, 2020

(51) Int. Cl. G06F 3/044

(52) U.S. Cl. CPC G06F 3/044; G06F 2203/04102

(57) ABSTRACT

A touch panel includes a group of edge portions that are connected to each other or close to each other. The group of edge portions includes a first edge portion and a second edge portion. The first edge portion is provided with a first edge sensing channel, and the second edge portion is provided with a second edge sensing channel. The first edge sensing channel and the second edge sensing channel which are arranged on the group of edge portions are electrically connected, together forming a same sensing channel. The present disclosure also provides a touch device and a manufacturing method for sensing channels of touch panel. The present disclosure can improve the touch sensitivity of the touch panel, reduce the risk of touch failure in the sensing blind zone, and also improve user experience.

### RELATED APPLICATIONS

The present application is a National Phase of International Application Number PCT/CN2018/087545, filed Mar. 18, 2018.

### TECHNICAL FIELD

The present disclosure relates to fields of touch technology, and in particular to a touch device, touch panel and manufacturing method for sensing channels of the touch panel.

### BACKGROUND

With the advancement of technology, touch technology have been widely used in various electronic products, which brings convenience to users. When the touch panel is arranged on a circumferential surface of the touch device, such as a side surface of the cylinder, or two or more touch panels are arranged side by side on a surface of the touch device (the circumferential surface or the surface on the same plane), the edges of the two ends of the touch panel that are connected to each other or close to each other have a fit tolerance, as shown in FIG. 1, the sensing channels 71 and 72 on the two ends of the touch panel corresponding to a joint have a non-functional area of about 3˜4 mm, that is, a sensing blind zone. When the sensing blind zone is touched, because the left and right sensing channels belong to different channels, and the contact area of the touch object (including human fingers or stylus, etc.) on the touch panel is small, the phenomenon of touch insensitivity will occur, thereby affecting the user experience.

### SUMMARY

The present disclosure provides a touch device, a touch panel, and a manufacturing method for sensing channels of the touch panel, which can improve a touch sensitivity of the touch panel and reduce a risk of touch failure in a sensing blind zone.

In a first aspect, the present disclosure provides a touch panel including a group of edge portions that are connected to each other or close to each other, the group of edge portions including a first edge portion and a second edge portion. The first edge portion is provided with a first edge sensing channel, and the second edge portion is provided with a second edge sensing channel. The first edge sensing channel and the second edge sensing channel which are arranged on the group of edge portions are electrically connected, together forming a same sensing channel.

In a second aspect, the present disclosure provides a touch device including a main body and a touch panel arranged on an outer surface of the main body. The touch panel includes a group of edge portions that are connected to each other or close to each other, and the group of edge portions includes a first edge portion and a second edge portion. The first edge portion is provided with a first edge sensing channel, and the second edge portion is provided with a second edge sensing channel. The first edge sensing channel and the second edge sensing channel which are arranged on the group of edge portions are electrically connected, together forming a same sensing channel.

In a third aspect, the present disclosure provides a manufacturing method for sensing channels of a touch panel. The touch panel includes a group of edge portions connected to each other or close to each other, and the group of edge portions includes a first edge portion and a second edge portion. The method includes following steps.

A first edge sensing channel is arranged on the first edge portion of the group of edge portions, and a second edge sensing channel is arranged on the second edge portion of the group of edge portions.

The first edge sensing channel and the second edge sensing channel which are arranged on the group of edge portions are connected electrically, together forming a same sensing channel.

In the present disclosure, the edge sensing channels arranged on the two edge portions that are connected to each other or close to each other are together forming the same sensing channel, which can improve the touch sensitivity of the touch panel and reduce the risk of touch failure in the sensing blind zone, and also improve user experience.

### BRIEF DESCRIPTION OF THE ACCOMPANYING DRAWINGS

In order to more clearly describe the technical solutions in the embodiments of the present disclosure or the prior art, the following will briefly introduce the drawings that need to be used in the description of the embodiments or the prior art. Obviously, the drawings in the following description are only some embodiments of the present disclosure. For those of ordinary skill in the art, other drawings can be obtained based on these drawings without creative work.

FIG. 1 is a schematic structural diagram of sensing channels of a touch panel in a prior art.

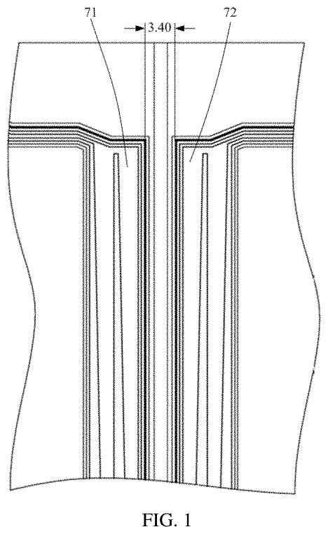

FIG. 2 is a schematic structural diagram of a touch device provided by an embodiment of the present disclosure.

FIG. 3 is a schematic structural diagram of a touch panel provided by an embodiment of the present disclosure.

FIG. 4 is a schematic structural diagram of another touch panel provided by an embodiment of the present disclosure.

FIG. 5 is an enlarged schematic diagram of a partial structure of the touch panel shown at II in FIG. 3.

FIG. 6 is an enlarged schematic diagram of a partial structure of a group of edge portions that are connected to each other or close to each other of the touch panels shown at III in FIG. 4.

FIG. 7 is an enlarged schematic diagram of a partial structure of the touch panel shown at IV in FIG. 4.

FIG. 8 is a schematic diagram of equivalent connections of edge sensing channels on the group of edge portions of the touch panel provided by an embodiment of the present disclosure.

FIG. 9 is a flowchart of a manufacturing method for sensing channels of the touch panel according to an embodiment of the present disclosure.

### DETAILED DESCRIPTION OF ILLUSTRATED EMBODIMENTS

The technical solutions in the embodiments of the present disclosure will be described clearly and completely with reference to the drawings in the embodiments of the present disclosure. Obviously, the described embodiments are only a part of the embodiments of the present disclosure, but not all the embodiments. All other embodiments obtained by those of ordinary skill in the art based on the embodiments in the present disclosure without creative work shall fall within the protection scope of the present disclosure.

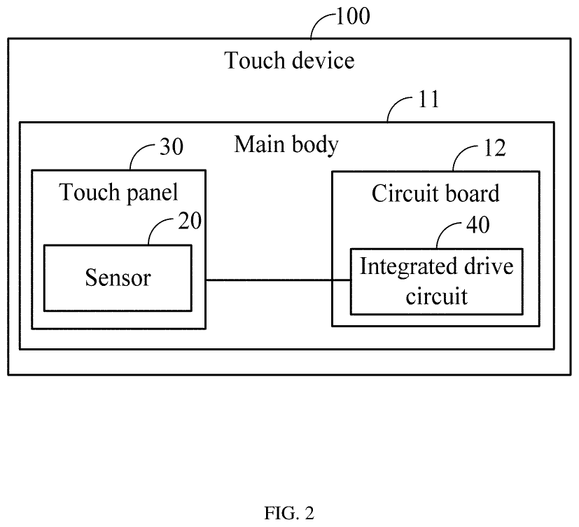

Referring to FIG. 2, a schematic structural diagram of a touch device 100 provided by an embodiment of the present disclosure is illustrated. In this embodiment, the touch device 100 at least includes a main body 11, a circuit board 12, a touch panel 30 including a plurality of touch sensors 20, and an integrated drive circuit 40. The integrated drive circuit 40 can be arranged on the circuit board 12. The touch panel 30 is arranged on an outer surface of the main body 11 and is used to complete a touch sensing control function through the plurality of touch sensors 20. The touch panel 30 is an inductive panel that can accept input signals of a touch contact such as a human finger or a stylus, for example, a capacitive thin film sensing touch panel. The integrated drive circuit 40 is used to perform corresponding drive control on the touch sensor 20 to realize the touch sensing control function.

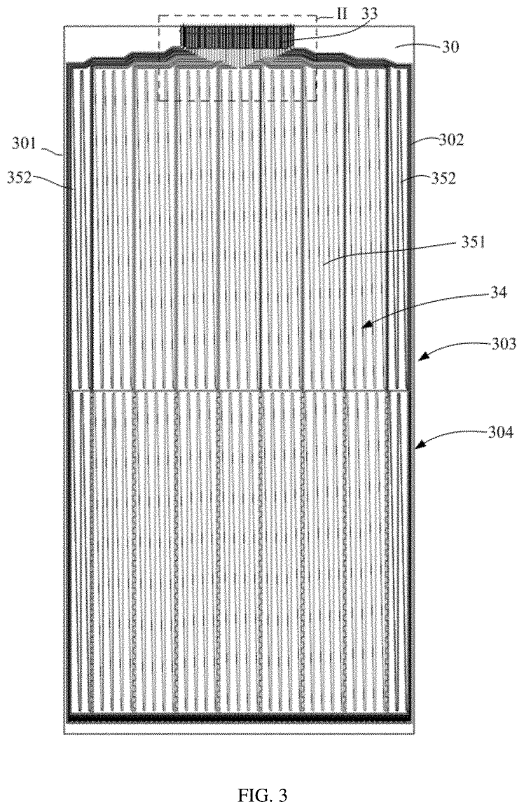

In this embodiment, the touch panel 30 includes at least one group of edge portions that are connected to each other or close to each other. In one embodiment, the main body 11 may be a column, and the touch panel 30 may be folded and attached to an outer surface of the main body 11 around an axial direction of the main body 11. As shown in FIG. 3, it is a schematic diagram of the touch panel 30 being unfolded and laid flat on a plane. When the touch panel 30 is attached to the outer surface of the main body 11, the opposite ends 301, 302 are folded toward each other, so that the opposite ends 301, 302 are connected to each other or close to each other, and the opposite ends 301, 302 connected to each other or close to each other constitute a group of edge portions. That is, in one embodiment, the two ends constituting the group of edge portions are the two ends of a same touch panel.

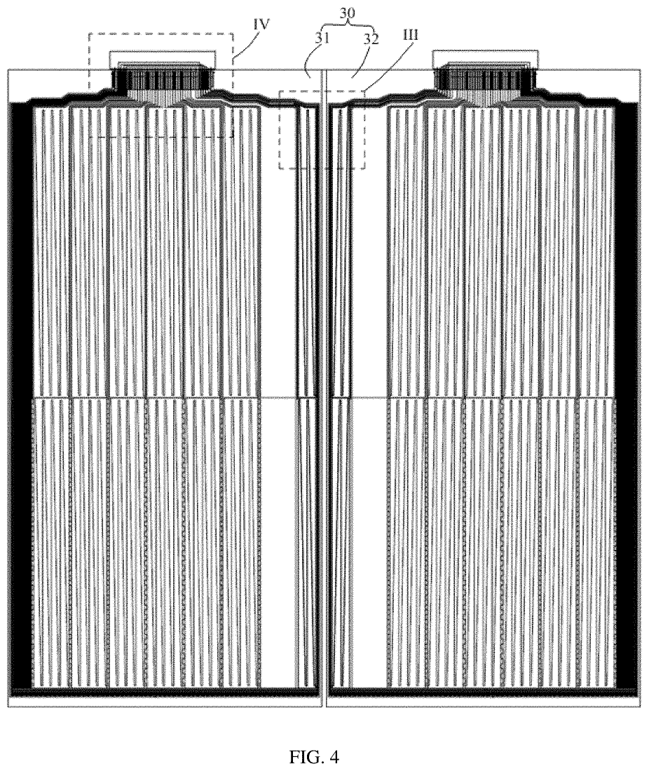

Optionally, in another embodiment, the touch panel 30 may include two or more touch panels. The touch device 100 may include a columnar main body, and the two or more touch panels may be attached to an outer surface of the main body side by side around an axial direction of the main body after bending, or, the touch device 100 may include a flat main body, and the two or more touch panels are laid side by side on the outer surface of the main body. As shown in FIG. 4, it is a schematic diagram of the two touch panels 31, 32 of the touch panel 30 being expanded and laid flat on a plane. The two adjacent touch panels 31, 32 are connected to each other or close to each other to form the group of edge portions. That is to say, in the other embodiment, the two ends constituting each group of edge portions are the ends of two different touch panels.

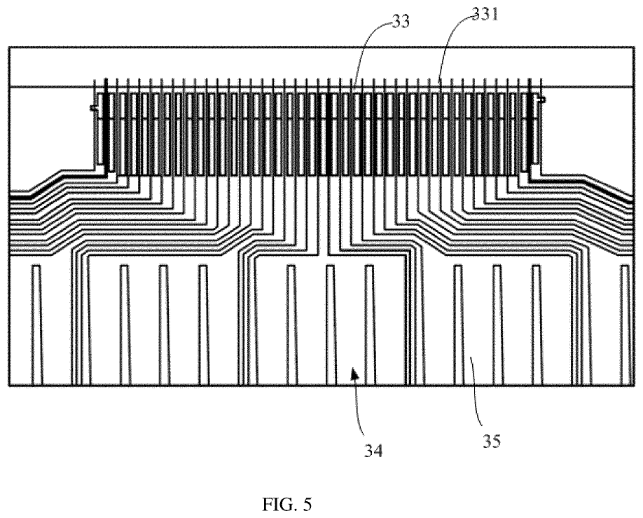

FIG. 5 is an enlarged schematic diagram of a partial structure of the touch panel 30 shown at II in FIG. 3. The touch panel 30 includes a lead wire area 33 and a sensing area 34. The lead wire area 33 is provided with a plurality of lead wires 331, and the plurality of lead wires 331 are used to connect the sensing area 34 and the integrated drive circuit 40 electrically.

A plurality of sensing channels 35 are provided on the sensing area 34, and the plurality of sensing channels 35 form a plurality of touch sensors 20. Referring to FIGS. 3 and 5 together, the plurality of sensing channels 35 include a plurality of middle sensing channels 351 located in a middle area of the sensing area 34 and at least two edge sensing channels 352 located in edge areas of the sensing area 34. The touch sensor 20 can determine a capacitance change of the touch panel 30 according to a capacitance value detected by the corresponding sensing channel 35.

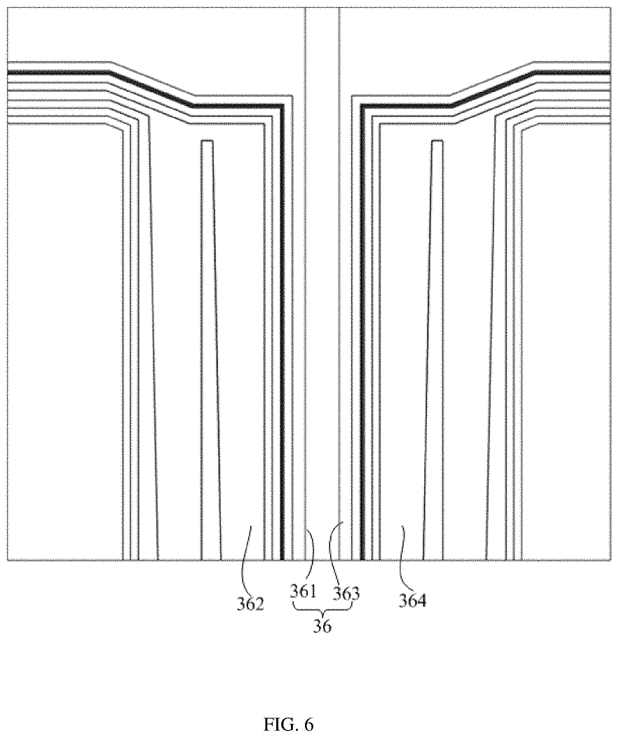

FIG. 6 is an enlarged schematic diagram of a partial structure of a group of edge portions that are connected to each other or close to each other of the touch panels shown at III in FIG. 4. The group of edge portions 36 include a first edge portion 361 and a second edge portion 363. The first edge portion 361 is provided with a first edge sensing channel 362. The second edge portion 363 is provided with a second edge sensing channel 364.

It can be understood that, corresponding to the embodiment shown in FIG. 3, when the touch panel 30 is unfolded, the first edge portion and the second edge portion are located on opposite sides, and when the touch panel 30 is folded, the first edge portion 361 and the second edge portion 363 are connected to each other or close to each other.

In this embodiment, the first edge sensing channel 362 and the second edge sensing channel 364 which are arranged on the group of edge portions 36 are electrically connected, together forming the same sensing channel. In this way, when a touch object touches the area between the first edge portion 361 and the second edge portion 363 included in each group of edge portions 36, since the first edge sensing channel 362 and the second edge sensing channel 364 which are arranged on each group of edge portions 36 belong to the same sensing channel, the total touch area of the touch surface is equal to a sum of the touch areas of the first edge sensing channel 362 and the second edge sensing channel 364, thereby greatly improving the touch sensitivity.

In one embodiment, when the outer surface of the main body 11 of the touch device 100 is relatively long, as shown in FIG. 3, the touch panel 30 may further include an upper panel 303 and a lower panel 304. The edge sensing channels provided on the group of edge portions that are connected to each other or close to each other on the upper panel 303 are electrically connected, together forming a same sensing channel. The edge sensing channels provided on the group of edge portions that are connected to each other or close to each other on the lower panel 304 are connected, together forming another same sensing channel.

In this embodiment, each of the sensing channels 35 includes a big end and a small end. Both the big end and the small end have a shape with a gradual width, where the wider end of the big end is connected to a connecting line, the narrow end of the small end is connected to a connecting line. The big end of the first edge sensing channel 362 and the big end of the second edge sensing channel 364 which are arranged on the group of edge portions 36 are electrically connected, and the small end of the first edge sensing channel 362 and the small end of the second edge sensing channel 364 which are arranged on the group of edge portions 36 are electrically connected.

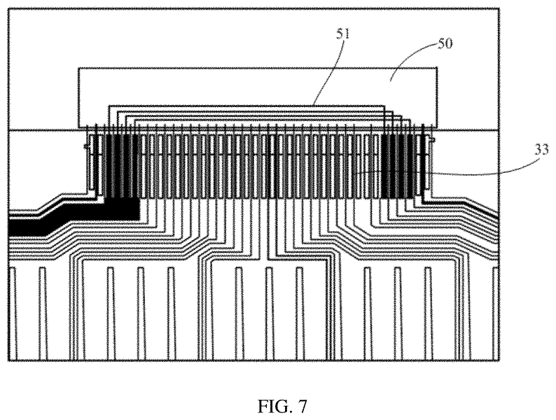

FIG. 7 is an enlarged schematic diagram of a partial structure of the touch panel 30 shown at IV in FIG. 4. As shown in FIG. 7, in this embodiment, the touch device 100 further includes connecting lines 51. The first edge sensing channel 362 and the second edge sensing channel 364 which are arranged on the group of edge portions 36 are electrically connected by the connecting lines 51, together forming a same sensing channel. Specifically, the big end of the first edge sensing channel 362 is electrically connected to the big end of the second edge sensing channel 364 through the connecting lines 51, and the small end of the first edge sensing channel 362 is electrically connected to the small end of the second edge sensing channel 364 through the connecting lines 51.

In this embodiment, since the first edge portion and the second edge portion included in each group of edge portions 36 are connected to each other or close to each other, a gap is formed between the first edge portion and the second edge portion, and the connecting lines 51 are located outside of a range of the gap.

Optionally, in an implementation manner, the connecting lines 51 are arranged on the lead wire area 33.

Optionally, in another embodiment, the touch device 100 further includes a flexible circuit board (Flexible Printed Circuit, FPC) 50 arranged outside the touch panel 30, and the connecting lines 51 are arranged on the FPC 50.

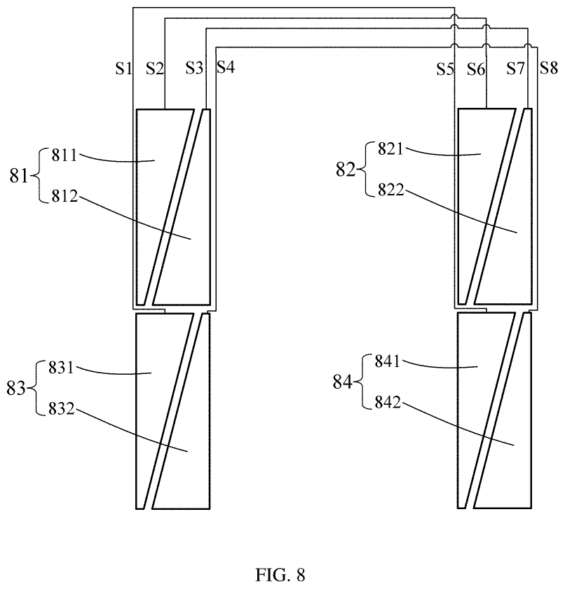

For example, please referring to FIG. 8, a schematic diagram of equivalent connections of edge sensing channels on the group of edge portions of the touch panel provided by an embodiment of the present disclosure is illustrated. The touch panel includes an upper panel and a lower panel, wherein a group of edge portions (ie, left edge portion and right edge portion) of the upper panel are respectively provided with a first edge sensing channel 81 (ie left edge sensing channel) and a second edge sensing channel 82 (ie, right edge sensing channel), where the first edge sensing channel 81 includes a big end 811 and a small end 812, and the second edge sensing channel 82 includes a big end 821 and a small end 822. The connecting line S2 of the big end 811 of the first edge sensing channel 81 is electrically connected to the connecting line S6 of the big end 821 of the second edge sensing channel 82, and the connecting line S3 of the small end 812 of the first edge sensing channel 81 is electrically connected to the connecting line S7 of the small end 822 of the the second edge sensing channel 82.

A group of edge portions (ie, left edge portion and right edge portion) of the lower panel are respectively provided with a first edge sensing channel 83 (ie, left edge sensing channel) and a second edge sensing channel 84 (ie, right edge sensing channel), where the first edge sensing channel 83 includes a big end 831 and a small end 832, and the second edge sensing channel 84 includes a big end 841 and a small end 842. The connecting line S1 of the big end 831 of the first edge sensing channel 83 is electrically connected to the connecting line S5 of the big end 841 of the second edge sensing channel 84, and the connecting line S4 of the small end 832 of the first edge sensing channel 83 is electrically connected to the connecting line S8 of the small end 842 of the second edge sensing channel 83.

The touch panel and touch device provided in the present disclosure combine the edge sensing channels which are arranged on the two edge portions that are connected or close to each other into the same sensing channel, thereby improving the touch sensitivity of the touch panel and reducing a risk of touch failure of the blind area, and also improving the user experience.

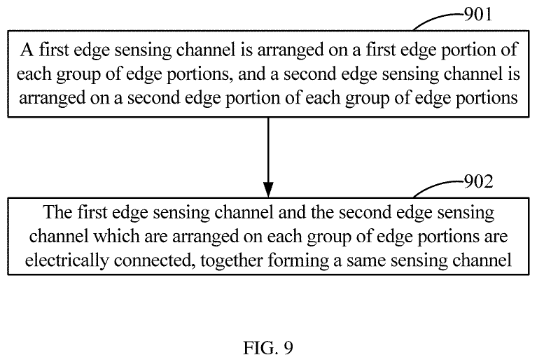

Referring to FIG. 9, a flowchart of a manufacturing method for sensing channels of a touch panel according to an embodiment of the present disclosure is illustrated. The method can be applied to the touch panel of the embodiment shown in FIGS. 2-8. As shown in FIG. 9, the method includes the following steps.

Block 901, a first edge sensing channel is arranged on the first edge portion of each group of edge portions, and a second edge sensing channel is arranged on the second edge portion of each group of edge portions.

Block 902, the first edge sensing channel and the second edge sensing channel which are arranged on each group of edge portions are electrically connected, together forming a same sensing channel.

In this embodiment, the first edge sensing channel and the second edge sensing channel each includes a big end and a small end respectively. The block 902 includes: the big end of the first edge sensing channel portion and the big end of the second edge sensing channel which are arranged on each group of edge portions are electrically connected, and the small end of the first edge sensing channel portion and the small end of the second edge sensing channel which are arranged on each group of edge portions are electrically connected.

In one embodiment, the block 902 includes: the first edge sensing channel and the second edge sensing channel which are arranged on each group of edge portions are electrically connected through the connecting lines, together forming the same sensing channel.

Optionally, in some embodiments, the touch panel includes a lead wire area, and the connecting lines are arranged on the lead wire area.

Optionally, in another embodiment, the connecting lines are arranged on a flexible circuit board outside the touch panel.

The manufacturing method for the sensing channel of the touch panel provided in the present disclosure combines the edge sensing channels which are arranged on the two edge portions that are connected to each other or close to each other into the same sensing channel, thereby improving the touch sensitivity of the touch panel and reducing the risk of touch failure in the blind zone and improving the user experience.

Finally, it should be noted that the above embodiments are only used to illustrate the technical solutions of the present disclosure and not to limit it. Although the present disclosure has been described in detail with reference to the above preferred embodiments, those of ordinary skill in the art should understand that the technology of the present disclosure can be modification or equivalent replacement of the solution should not depart from the spirit and scope of the technical solution of the present disclosure.

1. A touch panel comprising a group of edge portions that are connected to each other or close to each other, the group of edge portions comprising a first edge portion and a second edge portion, the first edge portion being provided with a first edge sensing channel, and the second edge portion being provided with a second edge sensing channel, wherein the first edge sensing channel and the second edge sensing channel which are arranged on the group of edge portions are electrically connected, together forming a sensing channel.

2. The touch panel according to claim 1, wherein the first edge sensing channel and the second edge sensing channel each comprises a big end and a small end, wherein the big end of the first edge sensing channel and the big end of the second edge sensing channel which are arranged on the group of edge portions are electrically connected, and the small end of the first edge sensing channel and the small end of the second edge sensing channel which are arranged on the group of edge portions are electrically connected.

3. The touch panel according to claim 1, wherein the first edge sensing channel and the second edge sensing channel which are arranged on the group of edge portions are electrically connected by connecting lines, together forming the same sensing channel.

4. The touch panel according to claim 3, wherein the touch panel comprises a lead wire area, and the connecting lines are arranged on the lead wire area.

5. The touch panel according to claim 3, wherein the connecting lines are provided on a flexible circuit board outside the touch panel.

6. The touch panel according to claim 3, wherein a gap is formed between the first edge portion and the second edge portion, and the connecting lines are located outside a range of the gap.

7. The touch panel according to claim 1, wherein when the touch panel is unfolded, the first edge portion and the second edge portion are located on opposite sides, and when the touch panel is folded, the first edge portion and the second edge portion are connected to each other or close to each other.

8. A touch device comprising a main body and a touch panel arranged on an outer surface of the main body, the touch panel comprising a group of edge portions that are connected to each other or close to each other, and the group of edge portions comprising a first edge portion and a second edge portion, the first edge portion being provided with a first edge sensing channel, and the second edge portion being provided with a second edge sensing channel, wherein the first edge sensing channel and the second edge sensing channel which are arranged on the group of edge portions are electrically connected, together forming a same sensing channel.

9. The touch device according to claim 8, wherein the first edge sensing channel and the second edge sensing channel each comprises a big end and a small end, and the big end of the first edge sensing channel and the big end of the second edge sensing channel which are arranged on the group of edge portions are electrically connected, and the small end of the first edge sensing channel and the small end of the second edge sensing channel which are arranged on the group of edge portions are electrically connected.

10. The touch device according to claim 8, wherein the touch device further comprises connecting lines, and the first edge sensing channel and the second edge sensing channel which are arranged on the group of edge portions are electrically connected through the connecting lines, together forming the same sensing channel.

11. The touch device according to claim 10, wherein the touch panel comprises a lead wire area, and the connecting lines are arranged on the lead wire area.

12. The touch device according to claim 10, wherein the touch device further comprises a flexible circuit board arranged outside the touch panel, and the connecting lines are arranged on the flexible circuit board.

13. The touch device according to claim 10, wherein the first edge portion and the second edge portion are located on opposite sides when the touch panel is unfolded, and the first edge portion and the second edge portion are connected to each other or close to each other when the touch panel is folded.

14. The touch device according to claim 8, wherein the first edge portion and the second edge portion are located on opposite sides when the touch panel is unfolded, and the first edge portion and the second edge portion are connected to each other or close to each other when the touch panel is folded.

15. A manufacturing method for sensing channels of a touch panel, the touch panel comprising a group of edge portions connected to each other or close to each other, and the group of edge portions comprising a first edge portion and a second edge portion, wherein the method comprises:
arranging a first edge sensing channel on the first edge portion of the group of edge portions, and arranging a second edge sensing channel on the second edge portion of the group of edge portions; and
connecting the first edge sensing channel and the second edge sensing channel which are arranged on the group of edge portions electrically, together forming a same sensing channel.

16. The method according to claim 15, wherein the first edge sensing channel and the second edge sensing channel each comprises a big end and a small end, and the method comprises:
connecting the big end of the first edge sensing channel and the big end of the second edge sensing channel which are arranged on the group of edge portions electrically, and connecting the small end of the first edge sensing channel and the small end of the second edge sensing channel which are arranged on the group of edge portions electrically.

17. The method according to claim 15, wherein the method comprises:
connecting the first edge sensing channel and the second edge sensing channel which are arranged on the group of edge portions by connecting lines, together forming the same sensing channel.

18. The method according to claim 17, wherein the touch panel comprises a lead wire area, and the connecting lines are arranged on the lead wire area.

19. The method according to claim 17, wherein the connecting lines are arranged on a flexible circuit board outside the touch panel.

20. The method according to claim 17, wherein a gap is formed between the first edge portion and the second edge portion, and the connecting lines are located outside a range of the gap.
